(19) United States
(12) Patent Application Publication
(10) Pub. No.: US 2009/0013009 A1
(43) Pub. Date: Jan. 8, 2009

(54) Using differential file representing differences of second version of a file compared to first version of the file

(76) Inventor: Kiyotaka Nakayama, Tokyo (JP)

Correspondence Address: LAW OFFICES OF MICHAEL DRYJA, 1474 N COOPER RD #105-248, GILBERT, AZ, 85233, US

(21) Appl. No.: 11/772,770

(22) Filed: Jul. 2, 2007

(51) Int. Cl. G06F 17/30; G06F 15/16

(52) U.S. Cl. 707/203; 709/206; 707/E17.01

(57) ABSTRACT

A differential file based on a second version of a file compared to a first version of the file is generated. The differential file is smaller in size than the first and second versions of the file. The differential file represents differences of the second version of the file compared to the first version of the file. The differential file may be sent from a sender to a recipient via email in lieu of sending the second version of the file in its entirety. The differential file may be stored at a groupware system in lieu of indefinitely storing the second version of the file in its entirety. The differential file may be compressed and included within a compressed file also including the first version of the file, in lieu of including the second version of the file in its entirety within the compressed file.

### FIELD OF THE INVENTION

The present invention relates generally to a differential file representing differences of a second version of a file compared to a first version of the file, and more particularly to using such a differential file in email, groupware systems, or for compression, in lieu of the second version of the file in its entirety.

### BACKGROUND OF THE INVENTION

Computer files may be updated or modified periodically or rapidly over time. For example, two users may be working on the same legal contract document. The first user may generate a first version of the document and have the second user review it. The second user may then modify the first version to yield a second version of the document and have the first user review it. This process may continue back and forth a number of times iteratively.

Transmitting, storing, and/or compressing each version of the document as it is generated can be wasteful in terms of bandwidth or storage space. For example, just a few words may have changed from one version of the document to the next version. However, each new version of the document may nevertheless be transmitted, stored, and/or compressed as it is generated, even though a previous version—identical to the new version except for what may be just minor changes—has already been transmitted, stored, and/or compressed.

For these and other reasons, therefore, there is a need for the present invention.

### SUMMARY OF THE INVENTION

The present invention relates to using a differential file representing differences of a second version of a file compared to a first version of the file. In one embodiment, in response to a request by a sender to send the first version of the file via email to a recipient, the first version of the file is sent over a network via email, such that the first version of the file is sent in its entirety. In response to a request by the sender to a second a second version of the file via email to the recipient, the following is performed. A differential file is generated based on the second version of the file compared to the first version of the file. The differential file is smaller in size than the first and second versions of the file. The differential file represents differences of the second version of the file compared to the first version of the file. Just the differential file is sent over the network via email, in lieu of sending the second version of the file in its entirety.

In another embodiment, in response to a request by a poster to post the first version of the file on a groupware system—such as the Lotus Notes® groupware system, a wiki-style web site, or a blog—the first version of the file is stored at the groupware system. In response to a request by the poster to post a second version of the file on the groupware system, a differential file is generated based on the second version of the file compared to the first version of the file. The differential file is smaller in size than the first and second versions of the file. The differential file represents differences of the second version of the file compared to the first version of the file. Just the differential file is stored at the groupware system, in lieu of storing the second version of the file in its entirety.

In another embodiment, a differential file is generated based on the second version of the file compared to the first version of the file. The differential file is smaller in size than the first and second versions of the file. The differential file represents differences of the second version of the file compared to the first version of the file. The first version of the file and the differential file are compressed to yield a compressed file encompassing both the first and second versions of the file. The differential file is actually included within the compressed file in lieu of the second version of the file in its entirety to decrease the size of the compressed file as compared to as if the second version of the file were actually included within the compressed file. The compressed file is then output.

Embodiments of the invention provide for advantages over the prior art. In the email-related embodiment, sending just the differential file from the sender to the recipient, instead of sending the second version of the file in its entirety, results in bandwidth savings as compared to as if the second version of the file were sent in its entirety. In the groupware system-related embodiment, storing just the differential file at the groupware system, instead of storing the second version of the file in its entirety, results in storage savings as compared to as if the second version of the file were stored in its entirety. In the compression-related embodiment, including just the differential file (compressed) within the compressed file, instead of including the second version of the file (compressed) in its entirety within the compressed file, can result in bandwidth and/or storage savings when the compressed file is output.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram for using a differential file representing differences of a second version of a file compared to a first version of the file, according to an email-related embodiment of the invention.

FIG. 2 is a flowchart of a method for using a differential file representing differences of a second version of a file compared to a first version of the file, according to an email-related embodiment of the invention.

FIG. 3 is a diagram for using a differential file representing differences of a second version of a file compared to a first version of the file, according to a groupware system-related embodiment of the invention.

FIG. 4 is a flowchart of a method for using a differential file representing differences of a second version of a file compared to a first version of the file, according to a groupware system-related embodiment of the invention.

FIG. 5 is a diagram for using a differential file representing differences of a second version of a file compared to a first version of the file, according to a compression-related embodiment of the invention.

FIG. 6 is a flowchart of a method for using a differential file representing differences of a second version of a file compared to a first version of the file, according to a compression-related embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Email-Related Embodiment

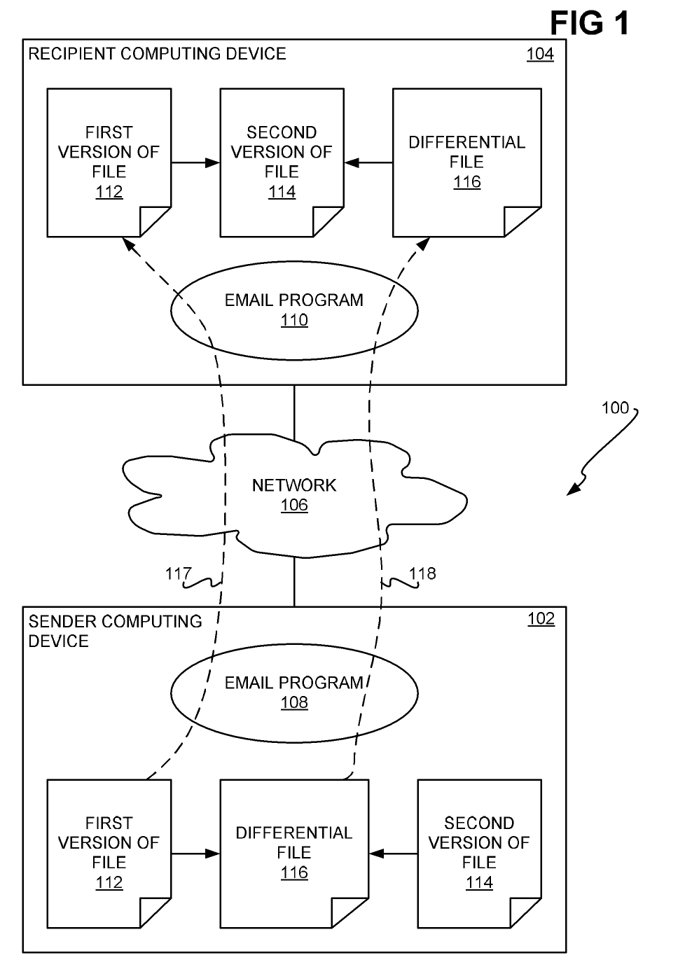

FIG. 1 shows a system 100, according to an email-related embodiment of the invention. The system 100 includes a sender computing device 102 and a recipient computing device 104 communicatively interconnected via a network 106. The network 106 may be or include local-area networks (LAN's), wide-area networks (WAN's), wired networks, wireless networks, the Internet, intranets, and extranets, as well as other types of networks.

The computing devices 102 and 104 may each be a desktop or a laptop computing device, or another type of computing device, such as a personal digital assistance (PDA) device, a smart phone, and so on. The sender computing device 102 includes an email program 108, while the recipient computing device 104 includes an email program 110. The email programs 108 and 110 are computer programs that permit the users of the computing devices 102 and 104 to send and receive email. An example of such an email program is Microsoft Outlook®, available from Microsoft Corp., of Redmond, Wash.

A sender, or user, at the sender computing device 102 first wishes to send a first version of a file 112 via email over the network 106 to a recipient, or user, at the recipient computing device 104. The file may be a data file, such as a word processing document, a spreadsheet, an image, or another type of data file, as well as another type of file altogether. The sender composes an email using the email program 108, and attaches the first version of the file 112 to this email. The email is addressed to the email address of the recipient at the recipient computing device 104. The sender sends the email using the email program 108 over the network 106 to the email address of the recipient, and the recipient receives this email, including the first version of the file 112, at the email program 110, as indicated by the arrow 117.

The sender then wishes to second a second version of the file 114 over the network 106 to the recipient at the recipient computing device 104. The sender again composes an email using the email program 108, addressed to the recipient at the recipient computing device 104. When requesting that the email program 108 attach the second version of the file 114 to this email, however, the email program 108 recognizes that the file that is desired to be attached is a second version of the file that was already sent to the recipient. Therefore, the email program 108 instead generates a differential file 116, which represents the differences between the second version of the file 114 as compared to the first version of the file 112. The email program 108 may have this functionality built-in, it may use an external program to generate the differential file 116, or a plug-in may have been previously installed within the email program 108 to provide for this functionality.

The differential file 116, which may also be referred to as a delta file, represents just the differences of the second version of the file 114 as compared to the first version of the file 112. Those parts of the file that remain the same between the second version 114 and the first version 112 are not included in the differential file 116. Therefore, the differential file 116 is smaller in size than both the first version 112 and the second version 114 of the file in question. The email program 108 may ask the sender whether he or she wishes to send the differential file 116 in lieu of the second version of the file 114, or may perform this action without asking the sender. In either case, the differential file 116 is generated automatically, without a user having to manually cause the differential file 116 to be generated—that is, the user does not have to him or herself operate or control a separate computer program to generate the differential file 116.

Thus, the email program 108 sends the email including the differential file 116 to the recipient, and the recipient receives this email at the email program 110, as indicated by the arrow 118. The email program 110 may display the identity of the differential file 116 as being the differential file 116, or it may display the identity of the differential file as being the second version of the file 114, since it is the second version of the file 114 that the recipient may be particularly interested in, as opposed to just the differential file 116. In either case, when the recipient wishes to view the file attached to this email, the email program 110 may automatically generate the second version of the file 114 from the previously received first version of the file 112 and the differential file 116, and then display or otherwise output the second version of the file 114.

The email program 110 may have this functionality built-in, it may use an external program to generate the second version of the file 114, or a plug-in may have been previously installed within the email program 110 to provide for this functionality. The email program 110 may notify the recipient that it is generating the second version of the file 114 from the first version of the file 112 and the differential file 116. In one embodiment, the email program 110 may also ask the recipient whether he or she wishes to generate the second version of the file 114 from the first version of the file 114 and the differential file 116 for display or other output. In any case, the second version of the file 114 is generated automatically; the recipient does not have to manually cause the second version of the file 114 to be created by, for instance, controlling or operation an external program to generate the second version of the file 114.

As such, in the email-related embodiment of FIG. 1, the second version of the file 114 is never in its entirety sent from the sender at the sender computing device 102 to the recipient at the recipient computing device 104. Rather, just the first version of the file 112 is sent, as is the differential file 116 that represents the differences between the first version 112 and the second version of the file 114. Because the differential file 116 is smaller than the second version of the file 114 in particular, there is a savings in bandwidth in transmitting the differential file 116 instead of the second version of the file 114 in its entirety. The recipient is still able to generate and display or otherwise output the second version of the file 114, which is generated at the recipient computing device 104 based on the first version of the file 112 and the differential file 116 that has been received.

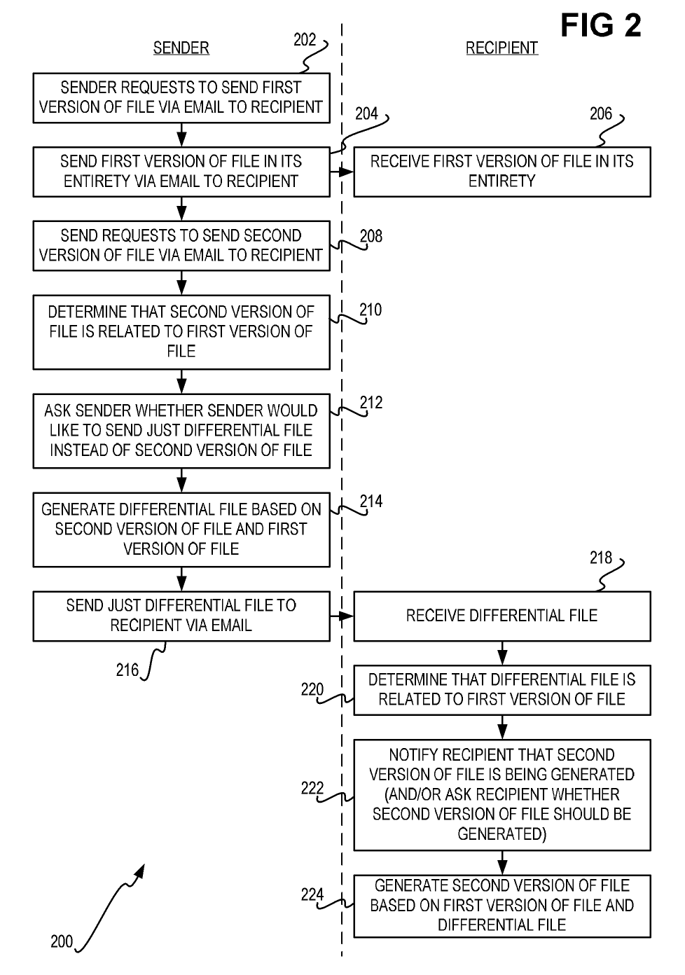

FIG. 2 shows a method 200, according to an email-related embodiment of the invention. The parts of the method 200 in the left-hand column of FIG. 2 are performed at the sender computing device 102 and/or by the sender, or user, of the sender computing device 102. For instance, these parts may be performed by the email program 108. The parts of the method 200 in the right-hand column of FIG. 2 are performed at the recipient computing device 104 and/or by the recipient, or user, of the recipient computing device 104. For instance, these parts may be performed by the email program 110.

The sender requests that the first version of the file 112 be sent via email to the recipient (202). In response, an email including the first version of the file 112 is sent to the recipient (204), and is received by the recipient (206). The sender then requests that the second version of the file 114 be sent via email to the recipient (208). In response, the email program 108 determines that the second version of the file 114 is related to the first version of the file 112 (208). In one embodiment, where the first and second versions of the file in question share a common prefix, middle part, or suffix in their filenames, then the email program 108 concludes that the second version of the file 114 is related to the first version of the file 112. In another embodiment, the email program 108 may conclude that the second version of the file 114 is related to the first version of the file 112 where the differences between these two versions are smaller in size than either of the first version 112 or the second version 114 of the file.

In one embodiment, the sender may therefore be asked by the email program 108, such as via a dialog box, whether just the differential file 116 should be sent instead of sending the second version of the file 114 in its entirety (212). Assuming that the sender answers in the affirmative in this embodiment, the differential file 116, if it has not already been generated, is generated based on the second version of the file 114 and the first version of the file 112 (214). An email including just the differential file 116, in lieu of the second version of the file 114 in its entirety, is sent to the recipient (216), and is received by the recipient (218).

The email program 110 determines that the differential file 116 is related to the first version of the file 112 that was previously received (220). In one embodiment, the differential file 116 may explicitly indicate that it is a differential file to be applied to the first version of the file 112 in order to generate the second version of the file 114, for instance. The email program 110 may notify the recipient that the second version of the file 114 is being generated (222), such as via a dialog box. The email program 110 may alternatively ask the recipient whether he or she wishes to view or otherwise output the second version of the file 114 based on the differential file 116 that has been received, in relation to the previously received first version of the file 112, or whether he or she wishes to view or otherwise output just the differential file 116 itself.

Assuming the former, the email program 110 generates the second version of the file 114 by applying the changes denoted in the differential file 116 to the first version of the file 112 (224), as can be appreciated by those of ordinary skill within the art. The recipient may view this second version of the file 114, or output it in another way, such as saving it to a storage like a hard disk drive, and so on. As such, the second version of the file 114 is never sent in its entirety from the sender to the recipient in the method 200, although the recipient nevertheless is able to have the second version of the file 114 generated, due to the first version of the file 112 and the differential file 116 that are sent from the sender to the recipient.

### Groupware System-Related Embodiment

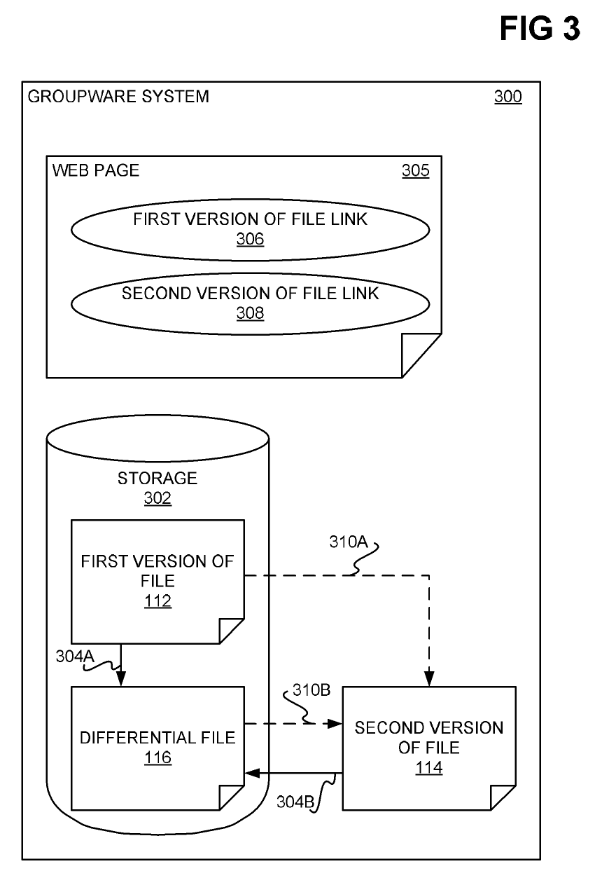

FIG. 3 shows a groupware system 300, according to a groupware-related embodiment of the invention. The groupware system 300 may include one or more server or other computing devices that have components such as memory, processors, and so on, as well as a storage 302, such as a hard disk drive. The groupware system 300 may be communicatively interconnected to one or more client computing devices via a network, which is not depicted in FIG. 3 for illustrative convenience. The groupware system 300 may be the Lotus Notes® groupware system, available from International Business Machines Corp., of Armonk, N.Y. The groupware system 300 may alternatively be or include a wiki-style web site, a blog, or another type of groupware system, as can be appreciated by those of ordinary skill within the art.

The groupware system 300 may expose a web site that includes one or more web pages, such as the web page 305. Posters, or users, may be permitted to post files to the groupware system 300, such that links to these files are displayed on the web pages. As such, viewers, or users, may be permitted to retrieve these files for viewing or other output by selecting the links to these files on the web pages. For instance, the web page 305 includes a link 306 to the first version of the file 112 and a link 308 to the second version of the file 114.

A poster, or user, may therefore initially post the first version of the file 112 and the second version of the file 114 to the groupware system 300, by uploading these versions from a client computing device to the groupware system 300. The first version of the file 112 is indefinitely stored on the storage 302 of the groupware system 300. Upon receipt of the second version of the file 114, however, the groupware system 300 determines that the second version of the file 114 is related to the first version of the file 112. Therefore, in lieu of storing the second version of the file 114 indefinitely on the storage 302, the groupware system 300 instead generates the differential file 116 based on the first version 112 and the second version 114 of the file in question, and stores the differential file 116 indefinitely on the storage 302. This process is indicated by the solid arrows 304A and 304B in FIG. 3.

As such, the second version of the file 114 is not stored indefinitely on the storage 302, and may be deleted or removed as soon as the differential file 116 is generated. When a viewer, or user, wishes to view or otherwise download or output the first version of the file 112, he or she selects the link 306, which causes the first version of the file 112 to be viewed or otherwise output or downloaded from the groupware system 300. As such, the link 306 may directly point to the first version of the file 112 stored on the storage 302.

Similarly, when a viewer, or user, wishes to view or otherwise download or output the second version of the file 114, he or she selects the link 308. However, the link 308 does not directly point to the second version of the file 114, since the second version of the file 114 is no longer stored on the storage 302. Rather, selection of the link 308 results in the second version of the file 114 being generated from the first version of the file 112 and the differential file 116 that are stored on the storage 302. This process is indicated by the dotted arrows 310A and 310B in FIG. 3. Once the second version of the file 114 has been displayed, downloaded, or output by the viewer in question, it may again be deleted or removed from the storage 302.

Therefore, the second version of the file 114 in its entirety is never indefinitely stored on the storage 302. It may only be stored on the storage 302 long enough for the differential file 116 to be generated when the second version of the file 114 is being posted to the groupware system 300, or when the second version 114 is to be displayed, downloaded, or output to or by a viewer. In the latter case, the viewer may be notified that the second version of the file 114 is being generated, such as via a dialog box. As in the email-related embodiment, in the groupware-related embodiment, users do not have to manually control or cause an external program to generate the differential file 116 (during posting) and the second version of the file 114 (during viewing). Rather, the differential file 116 is automatically generated during the posting process, and the second version of the file 114 is automatically generated during the viewing process.

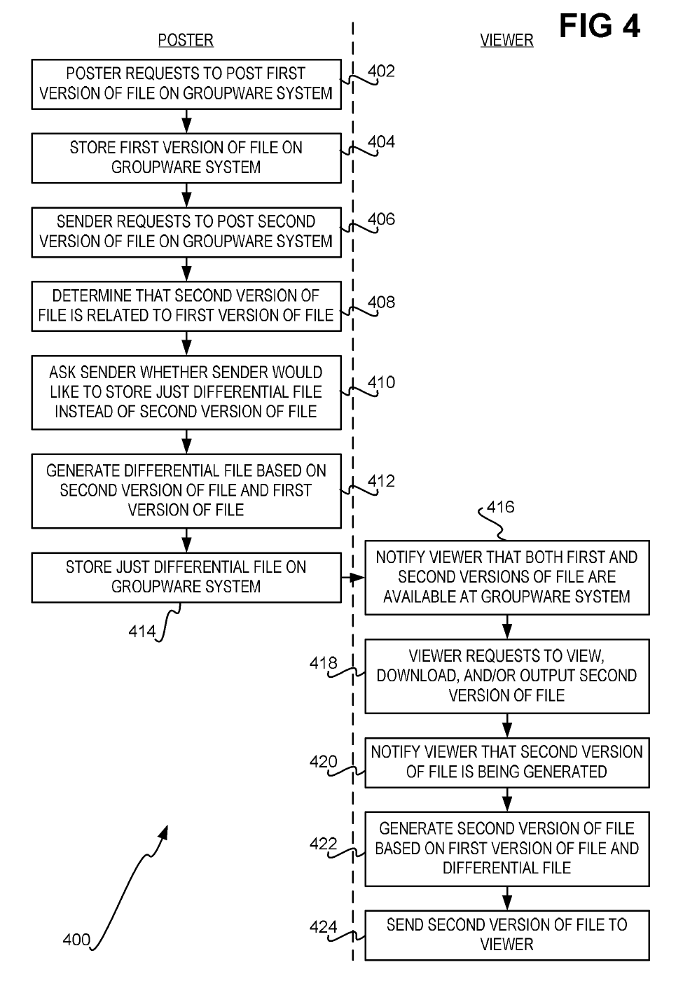

FIG. 4 shows a method 400, according to a groupware system-related embodiment of the invention. The parts of the method 400 in the left-hand column of FIG. 4 are performed in relation to a poster desiring to post files to the groupware system 300. By comparison, the parts of the method 400 in the right-hand column of FIG. 4 are performed in relation to a viewer desiring to view files that have been posted to the groupware system 300.

The poster, or user, requests that the first version of the file 112 be posted on the groupware system 300 (402). The user thus uploads the first version of the file 112 to the groupware system 300, where it is indefinitely stored on the storage 302 (404). Likewise, the poster requests that the second version of the file 114 be posted on the groupware system 300 (406). The user similarly uploads the second version of the file 114 to the groupware system 300. However, the groupware system 300 does not indefinitely store the second version of the file 114 on the storage 302.

Rather, the groupware system 300 determines that the second version of the file 114 is related to the first version of the file 112 (408), as has been described in relation to part 210 of the method 200 of FIG. 2. Assuming that the versions of the file in question are indeed related, in one embodiment the sender may be asked whether he or she would like to store just the differential file 116 at the storage 302 in lieu of storing the second version of the file 114. Assuming that the sender would like to store just the differential file 116, or where the sender is not asked this question, the differential file 116 is generated as has been described (412), and just the differential file 116 is indefinitely stored on the storage 302 (414). That is, the second version of the file 114 is not indefinitely stored on the storage 302, and may be deleted as soon as the differential file 116 has been generated.

A viewer may be notified that both the first version 112 and the second version 114 of the file in question are available at the groupware system 300 (416). Such notification may take the form of the links 306 and 308 to the first version 112 and the second version 114, respectively, of the file being displayed on the web page 305, as has been described. It is noted that even though the viewer is notified in this or another manner that the second version of the file 114 is in particular available at the groupware system 300, the groupware system 300 does not have stored indefinitely the second version of the file 114 on the storage 302. That is, the second version of the file 114 may indeed already have been deleted, and may not currently be stored on the storage 302.

The viewer requests to view, download, or otherwise output the second version of the file 114 (418), by, for instance, selecting the link 308 on the web page 305. In one embodiment, the viewer is notified, such as via a dialog box, that the second version of the file 114 is being generated (420). The second version of the file 114 is generated based on the first version of the file 112 and the differential file 116 (422), as has been described. The second version of the file 114 is then sent to the viewer for viewing or other output (424). For instance, the second version of the file 114 may be downloaded by the viewer. Once this process is complete, as before, the second version of the file 114 may be deleted, such that it is no longer currently stored on the storage 302.

### Compression-Related Embodiment

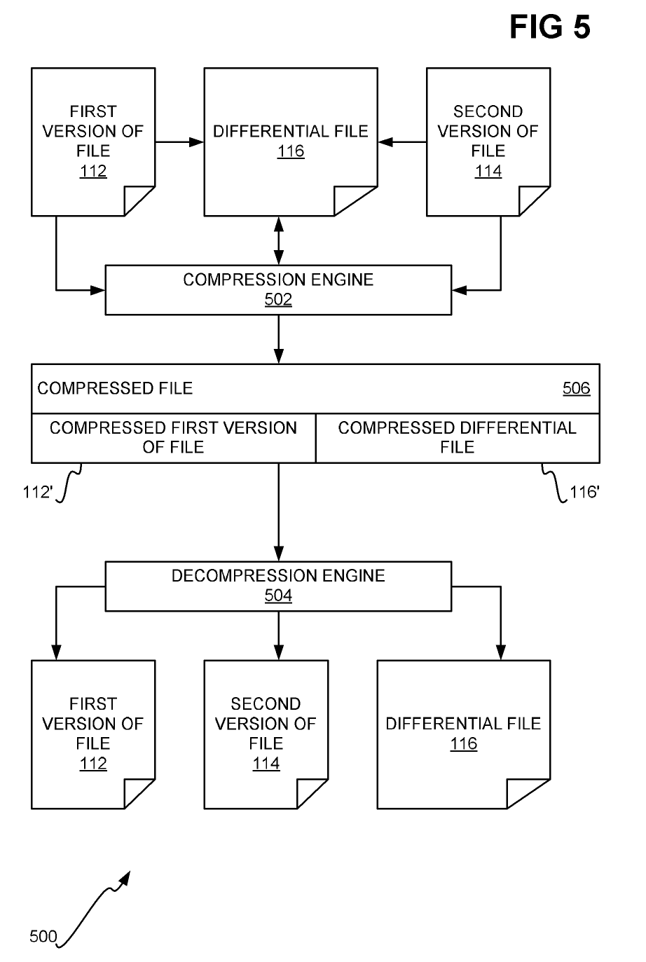

FIG. 5 shows a system 500, according to a compression-related embodiment of the invention. The system 500 may be implemented as one or more computing devices. The system 500 includes a compression engine 502 and a decompression engine 504. The engines 502 and 504 may be implemented in software, hardware, or a combination of software and hardware. In one embodiment, the engines 502 and 504 are part of the same computer program, such that this computer program can perform both compression and decompression.

The first version of the file 112 and the second version of the file 114 are input into the compression engine 502. The compression engine 502 generates the differential file 116 as has been described. The compression engine 502 may perform this functionality as being built-in, it may control an external program to generate the differential file 116, or it may have a plug-in that was previously installed and that is able to perform this functionality. Prior to generating the differential file 116, the compression engine 502 may verify or otherwise determine that the first version 112 and the second version 114 of the file in question are related, as has been described.

The compression engine 502 outputs, or generates, a compressed file 506. The compressed file 506 includes the first version of the file 112 as compressed, indicated by the reference number 112′, and the differential file 116 as compressed, indicated by the reference number 116′. Thus, the compressed file 506 includes two parts: a compressed part 112′ representing the first version of the file 112 after compression, and a compressed part 116′ representing the differential file 116 after compression. The manner by which the compression engine 502 performs compression is not limited by embodiments of the invention, as can be appreciated by those of ordinary skill within the art.

It is noted that the second version of the file 114 in its entirety is never by itself compressed by the compression engine 502, and thus there is no part within the compressed file 506 that directly corresponds to a compression rendition of the second version of the file 114. Rather, just the differential file 116 is compressed by the compression engine 502 in lieu of the second version of the file 114 being compressed. Likewise, just the differential file 116 has a directly corresponding part within the compressed file 506, indicated by the reference number 116′. This saves space within the compressed file 506, insofar as the differential file 116 is smaller in size than the second version of the file 114, such that the differential file 116 after compression is likely to be smaller in size than if the second version of the file 114 were compressed.

The compressed file 506 may be input into the decompression engine 504. The decompression engine 504 decompresses the first version of the file 112 from the compressed part 112′, and decompresses the differential file 116 from the compressed part 116′. The manner by which decompression is performed is not limited by embodiments of the invention, as can be appreciated by those of ordinary skill within the art. The decompression engine 504 then generates the second version of the file 114 automatically from the first version of the file 112 and the differential file 116, as has been described in relation to the other embodiments of the invention.

The user compressing the first version of the file 112 and the second version of the file 114 may not have to interact with the compression engine 502 to cause the differential file 116 to be generated and compressed as part of the compressed file 506 in lieu of the second version of the file 114 directly. Rather, the compression engine 502 may automatically determine that the first version 112 and the second version 114 of the file in question are related, and generate and compress the differential file 116 accordingly. Likewise, the user decompressing the compressed file 506 may not have to interact with the decompression engine 504 to cause the second version of the file 114 to be generated from the decompressed first version of the file 112 and the decompressed differential file 116. Rather, the decompression 504 may automatically generate the second version of the file 114 from the decompressed first version of the file 112 and the decompressed differential file 116.

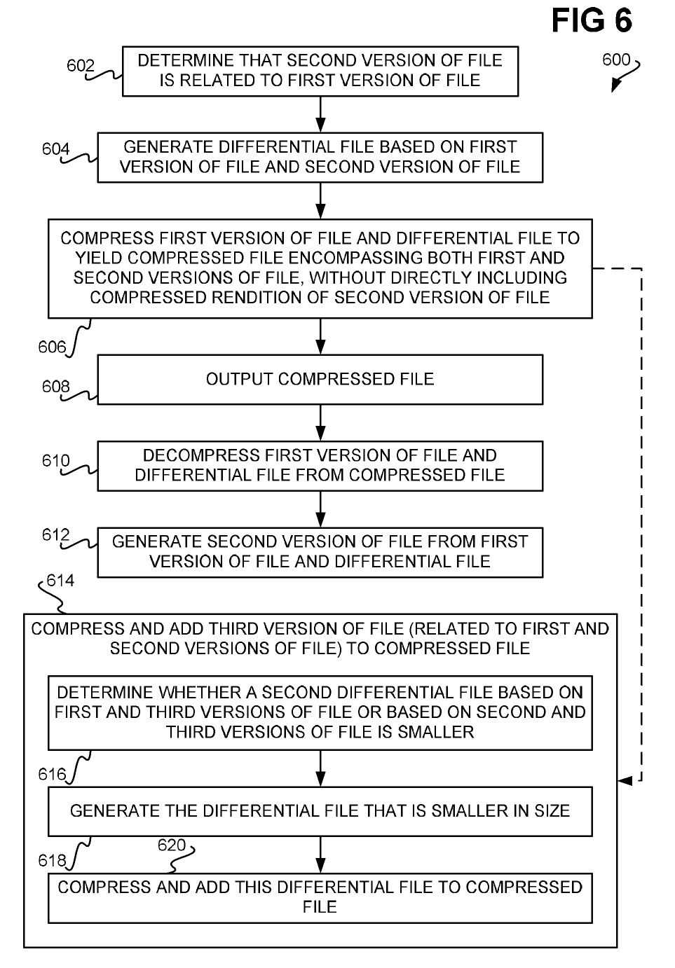

FIG. 6 shows a method 600, according to a compression-related embodiment of the invention. Parts 602, 604, 606, 608, and 614 are performed by the compression engine 502. By comparison, parts 610 and 612 are performed by the decompression engine 504. Besides the functionality described in relation to the system 500 of FIG. 5, additional functionality is described in conjunction with part 614 of the method 600 in FIG. 6. The method 600 presumes at least the first version of the file 112 and the second version of the file 114 are desired to be compressed within a compressed file 506.

Therefore, the compression engine 502 determines initially that the second version of the file 114 and the first version of the file 112 are related to one another (602), as has been described in conjunction with the email-related embodiment of the invention. Assuming that they are, the compression engine 502 generates the differential file 116 based on the first version of the file 112 and the second version of the file 114 (604). The compression engine 502 then compresses just the first version of the file 112 and the differential file 116 to yield the compressed file 506 (606). As such, the compressed file 506 is said to encompass both the first version 112 and the second version 114 of the file in question, without actually or directly including a compressed rendition of the second version of the file 114. A compression rendition of the differential file 116 is actually included within the compressed file 506 in lieu of a compressed rendition of the second version of the file 114 in its entirety to decrease the size of the compressed file, as compared to actual inclusion of a compressed rendition of the second version 114 within the compressed file 506.

The compressed file 506 is output (608). For instance, the compressed file 506 may be stored on a storage, like a hard disk drive, such that the compressed file 506 occupies less space on the storage as compared to as if the compressed file 506 were to actually include a compressed rendition of the second version of the file 114 instead of a compressed rendition of the differential file 116. As another example, the compressed file 506 may be sent over a network, such as by being attached to an email or uploaded. As such, the compressed file 506 takes up less bandwidth within the network as compared to as if the compressed file 506 were to actually include a compressed rendition of the second version of the file 114 instead of a compressed rendition of the differential file 116.

The compressed file 506 is input into the decompression engine 504 at some point, which decompresses the first version of the file 112 and the differential file 116 from the compressed file 506 (610). The decompression engine 504 then generates the second version of the file 114 from the first version of the file 112 (as decompressed) and the differential file 116 (as decompressed). As such, the second version of the file 114 is available after decompression, even though it was not actually or directly compressed within the compressed file 506, because the (smaller) differential file 116 was instead actually and directly compressed within the compressed file 506.

It is noted that a third version of the file may further be compressed and added to the compressed file 506 (614). In one embodiment, the compression engine 502 determines whether a (second, or additional) differential file based on the first version 112 and the third version of the file in question, or based on the second version 114 and the third version of the file in question, is smaller in size (616). That is, this second or additional differential file may represent differences between the third version of the file and the first version of the file 112, or it may represent differences between the third version of the file and the second version of the file 114. One of these two cases will likely result in a smaller differential file than the other case.

Therefore, the second or additional differential file that results in a smaller differential file is generated (618). For example, if a differential file representing the differences between the third version and the first version 112 of the file in question would be smaller than if it were to represent differences between the third version and the second version 114 of the file in question, than such a differential file is generated. Likewise, if a differential file representing the differences between the third version and the second version 114 of the file in question would be smaller than if it were to represent differences between the third version and the first version 112 of the file in question, then such a differential file is generated. This second or additional differential file, after generation, is compressed and added to the compressed file 506 (620), as an additional part of the compressed file 506.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method comprising:
in response to a request by a sender to send a first version of a file via email to a recipient, sending the first version of the file over a network via email, such that the first version of the file is sent in its entirety;
in response to a request by the sender to send a second version of the file via email to the recipient,
generating a differential file based on the second version of the file compared to the first version of the file, the differential file being smaller in size than the first and second versions of the file, the differential file representing differences of the second version of the file compared to the first version of the file; and,
sending just the differential file representing the differences of the second version of the file compared to the first version of the file over the network via email, in lieu of sending the second version of the file in its entirety.

2. The method of claim 1, further comprising determining that the second version of the file is related to the first version of the file, such that the differential file can be sent in lieu of the second version of the file.

3. The method of claim 1, further comprising:
receiving, by the recipient, the first version of the file from the sender over the network via email;
receiving, by the recipient, the differential file representing the differences of the second version of the file compared to the first version of the file from the sender over the network via email; and,
generating the second version of the file based on the first version of the file and the differential file representing the differences of the second version of the file compared to the first version of the file.

4. The method of claim 3, wherein the second version of the file is generated automatically, without the recipient having to manually cause the second version of the file to be generated.

5. The method of claim 3, further comprising, upon receiving the differential file, determining that the differential file is related to the first version of the file that has been received in its entirety, such that the second version of the file can be generated based on the first version of the file and the differential file.

6. The method of claim 3, further comprising notifying the recipient that the second version of the file is being generated based on the first version of the file and the differential file.

7. The method of claim 1, further comprising, in response to the request by the sender to send the second version of the file via email to the recipient:
determining that the second version of the file is related to the first version of the file, such that the differential file is smaller in size than the first and second versions of the file; and,
asking the sender whether the sender would like to send just the differential file to the recipient instead of the second version of the file in its entirety.

8. A method comprising:
in response to a request by a poster to post a first version of a file on a groupware system, storing the first version of the file at the groupware system;
in response to a request by the poster to post a second version of the file on the groupware system,
generating a differential file based on the second version of the file compared to the first version of the file, the differential file being smaller in size than the first and second versions of the file, the differential file representing differences of the second version of the file compared to the first version of the file; and,
storing just the differential file representing the differences of the second version of the file compared to the first version of the file at the groupware system, in lieu of indefinitely storing the second version of the file in its entirety.

9. The method of claim 8, further comprising notifying a viewer that both the first version and the second version of the file are available at the groupware system, even though just the differential file is stored at the groupware system as opposed to the second version of the file being indefinitely stored at the groupware system in its entirety.

10. The method of claim 8, further comprising determining that the second version of the file is related to the first version of the file, such that the differential file can be indefinitely stored in lieu of the second version of the file.

11. The method of claim 8, further comprising:
in response to a request by a viewer to retrieve the second version of the file from the groupware system,
generating the second version of the file based on the first version of the file and the differential file representing the differences of the second version of the file compared to the first version of the file; and,
sending the second version of the file as generated to the viewer.

12. The method of claim 11, wherein the second version of the file is generated automatically, without the viewer having to manually cause the second version of the file to be generated, the method further comprising notifying the recipient that the second version of the file is being generated based on the first version of the file and the differential file.

13. The method of claim 8, wherein the groupware system is one of a Lotus Notes® groupware system, a wiki-style web site, and a blog.

14. A method comprising:
generating a differential file based on a second version of a file compared to a first version of the file, the differential file being smaller in size than the first and second versions of the file, the differential file representing differences of the second version of the file compared to the first version of the file;
compressing the first version of the file and the differential file to yield a compressed file encompassing both the first and second versions of the file, where the differential file is actually included within the compressed file in lieu of the second version of the file in its entirety to decrease a size of the compressed file as compared to actual inclusion of the second version of the file within the compressed file; and,
outputting the compressed file.

15. The method of claim 14, wherein outputting the compressed file comprises one or more of:
storing the compressed file at a storage, such that the compressed file occupies less space on the storage as compared to as if the compressed file were to actually include the second version of the file instead of the differential file; and,
sending the compressed file over a network, such that the compressed file takes up less bandwidth within the network as compared to as if the compressed file were to actually include the second version of the file instead of the differential file.

16. The method of claim 14, determining that the second version of the file is related to the first version of the file, such that the differential file can be compressed and included within the compressed file in lieu of the second version of the file.

17. The method of claim 14, further comprising compressing and adding a third version of the file to the compressed file.

18. The method of claim 17, wherein the differential file representing the differences of the second version of the file compared to the first version of the file is a first differential file, and compressing and adding the third version of the file to the compressed file comprises:
generating a second differential file based on the third version of the file compared to the second version of the file, the second differential file being smaller in size than the first, second, and third versions of the file, the second differential file representing differences of the third version of the file compared to the second version of the file; and,
compressing the second differential file and adding the second differential file to the compressed file, such that the compressed file includes the first version of the file, the first differential file, and the second differential file, and the compressed file encompasses the first, second, and third versions of the file.

19. The method of claim 17, wherein the differential file representing the differences of the second version of the file compared to the first version of the file is a first differential file, and compressing and adding the third version of the file to the compressed file comprises:
generating a second differential file based on the third version of the file compared to the first version of the file, the second differential file being smaller in size than the first, second, and third versions of the file, the second differential file representing differences of the third version of the file compared to the first version of the file; and,
compressing the second differential file and adding the second differential file to the compressed file, such that the compressed file includes the first version of the file, the first differential file, and the second differential file, and the compressed file encompasses the first, second, and third versions of the file, such that the differential file is included within the compressed file in lieu of including the second version of the file in its entirety within the compressed file.

20. The method of claim 17, wherein the differential file representing the differences of the second version of the file compared to the first version of the file is a first differential file, and compressing and adding the third version of the file to the compressed file comprises:
determining whether a second differential file generated based on the third version of the file compared to the first version of the file or a third differential file based on the third version of the file compared to the second version of the file is smaller;
where the second differential file is smaller,
generating the second differential file based on the third version of the file compared to the first version of the file, the second differential file being smaller in size than the first, second, and third versions of the file, the second differential file representing differences of the third version of the file compared to the first version of the file;
compressing the second differential file and adding the second differential file to the compressed file, such that the compressed file includes the first version of the file, the first differential file, and the second differential file, and the compressed file encompasses the first, second, and third versions of the file;
where the third differential file is smaller,
generating the third differential file based on the third version of the file compared to the second version of the file, the third differential file being smaller in size than the first, second, and third versions of the file, the third differential file representing differences of the third version of the file compared to the second version of the file; and,
compressing the third differential file and adding the third differential file to the compressed file, such that the compressed file includes the first version of the file, the first differential file, and the third differential file, and the compressed file encompasses the first, second, and third versions of the file.
